(19) United States
(12) Patent Application Publication
(10) Pub. No.: US 2025/0186820 A1
(43) Pub. Date: Jun. 12, 2025

(54) AUTONOMOUS FIRE SUPPRESSION NOZZLE

(71) Applicant: Robin Jerry McDaniel, Two Rivers, WI (US)

(72) Inventor: Robin Jerry McDaniel, Two Rivers, WI (US)

(21) Appl. No.: 18/537,096

(22) Filed: Dec. 12, 2023

(51) Int. Cl. A62C 31/02; A62C 31/28; A62C 33/04

(52) U.S. Cl. CPC A62C 31/02; A62C 31/28; A62C 33/04

(57) ABSTRACT

An improved autonomous fire suppression nozzle and head assembly comprising a system of components to transport the “nozzle and head assembly” device, and moving the attached “hose”, via reactive jet propulsion, while utilizing no external moving parts, by the principle of acceleration of a fluid through lifting jet nozzles, and utilizing the hydraulic force of fluid pressure to assure fast propulsion.

A self-guided, self-stabilized, self-propelled, fire detecting, hose nozzle delivery device for the application of fire suppression fluids or gasses.

An invention for integrating the functions of fire detection, navigation, guidance, and control of the fire attack phase, by reactive flying of the assembly allowing for delivery of fire suppression over obstructed paths, up into tall structures, indoor flight through rooms and/or corridors, including internal vessel and outdoor fire fighting operations. Therefore application of this fire suppression system is desirable.

In summary, this autonomous fire nozzle and hose assembly device can be characterized as “a life saving device” because of the utilization of the dependable hydraulic forces to cause the AUTONOMOUS FIRE SUPPRESSION NOZZLE to travel quickly into a fire, instead of exposing people, to potential harm.

### FEDERALLY SPONSORED RESEARCH

Not Applicable

### SEQUENCE LISTING OR PROGRAM

Not Applicable
Current U.S. Class: 169/52; 169/53; 239/69
Current International Class: A62C 27/00
Field of Search: 169/52,53,62,67

### PREVIOUSLY DISCLOSED

This invention relates to previously applied Ser. No. 14/626,883 filed Mar. 16, 2013 by the inventor.

### BACKGROUND TECHNICAL FIELD

This invention relates to fire fighting nozzles in general and more specifically to autonomous nozzles of the self-erecting, movable, and airborne type.

### BACKGROUND DESCRIPTION OF PRIOR ART

### References Cited

U.S. Patent Documents

| | | |
|---|---|---|
| 2,023,028 | December 1935 | Offerdahl |
| 5,064,392 | September 1990 | Wonders |
| 5,860,479 | January 1999 | LaFolette |
| 2012/0285709 | May 2011 | McLoughlin et al. |
| 2013/0134254 | November 2011 | Moore |

Patents cited in previous application Office Action September 2016 for Ser. No. 14/626,883. Art Unit: 3752

A set of water propelled toys have been noted, describing curious devices that randomly or chaotically “fly” using water jets:

| | | |
|---|---|---|
| 2,024,339A | December 1935 | Connell |
| 2,921,743A | January 1960 | Westover |
| 2,954,923A | October 1960 | Albano et al. |
| 3,700,172A | October 1972 | Gallegos |
| 4,274,591A | June 1981 | Sunshine |
| 6,848,629B2 | February 2005 | Palmer |

Autonomous fire fighting systems differ from conventional fire equipment in that the operation may be independent of direct human control. Safer than to send a firefighter into a hazardous situation, is to deploy a robotic device into a dangerous environment to initially attack the fire thus freeing the human firefighters to perform rescue functions as required.

Attempts to protect human firefighters were evident in Offerdahl and Wonders, which proposed a jet propelled fire device deployed under a shore structure fire such as a burning pier. Ground vehicles have also been proposed, as in LaFollette, where tracked vehicles carried conventional fire nozzles up to the fire. The problem of hose deployment with such systems was previously addressed by McLoughlin, with a towed hose trailer deployment strategy. Current approaches with humanoid robots programmed to utilize conventional fire nozzle and hose combinations have been recently demonstrated with the DARPA/US Naval Research Laboratory project SAFFIR system.

Many differing attempts to utilize aircraft to fight outdoor or forest fires are well known in the art. Recently Moore proposed an UAV-based quadracopter configuration which carries aloft a conventional nozzle with a hose to deliver fluid to fight a fire.

These previously proposed devices may be better than sending a human firefighter into harms way, yet are complicated, heavy, slow, and/or may lack the payload required for the task.

### SUMMARY OF THE INVENTION

The present invention is made in view of the aforesaid problems in the related art.

An improved autonomous fire suppression nozzle and head assembly of the robotic type according to one embodiment of the present invention comprising a system of simple components to support the “hose”, transport the “the nozzle and head” device via reactive jet propulsion, while utilizing no external moving parts, by the principle of acceleration of a fluid through a plurality of lifting transportation nozzles, and utilizing the hydraulic force of fluid pressure to assure dependable jet propulsion.

The invention is a self-guided, self-propelled, fire detecting, hose and nozzle delivery device for the application of a multitude of fire suppression fluids or gasses. A single hydraulic core valve enclosed within a complex shaped body cavity, can control the travel and delivery functions of fire suppression fluid by an independent means utilizing a novel geometry.

A novel means for integrating the functions of navigation, fire detection, guidance, and control of the fire suppression fluid, without the use of a crawling, rolling, wing or leg utilizing robotic vehicle, yet by deploying “the nozzle and head” assembly, flying by jet propulsion, the invention allows for delivery of fire suppression over obstructed paths, up into tall structures, indoor flight through rooms and/or corridors, or outdoor operations. Therefore application of this fire suppression system is desirable.

By its design this device is automatically self-controlling in the case of loss of flow or pressure or accidental situation, as the “the nozzle and head” is supported by the reactive flow of the fluid. Thus if the flow creases, “the nozzle and head” is returned to a safe “resting” state.

In summary, this autonomous fire nozzle and head assembly device can be characterized as “a life saving device” because of the utilization of the dependable hydraulic forces to cause the device to travel quickly, instead of people, into harms way. Instead of inventing a mechanical firefighter, this is a “firefighter-less” autonomous nozzle and head.

### BRIEF DESCRIPTION OF THE DRAWINGS

Illustrative and presently selected embodiments of the invention are shown in the accompanying drawings in which:

FIG. 1 is a schematic overview of the component relationships of the autonomous fire suppression nozzle and head assembly according to one embodiment of the present invention;

FIG. 2 is a sectional view of a representation the components of the autonomous fire suppression nozzle and head assembly according to one embodiment of the present invention;

FIG. 3 is an overview of an embodiment of a fire fighting system showing the preflight ready mode, prior to the launch and travel phase of operations;

FIG. 4 is an overview of an embodiment of a fire fighting system showing the invention utilized for a high-rise building fire mission in multiple roles of hose delivery, manual attack, or autonomous operation. Shown as deployed independently or with other fire fighting assets.

### REFERENCE NUMERALS USED IN DRAWINGS

A Nozzle and Head Assembly
B Hose Components
C Fluid and Energy Reservoir
1 Guidance Computer/Communications Unit
2 3-Axis Gyroscope and 3-Axis Accelerometer
3 Electrical Power Source
4 Sensor Array
5 Valve Actuators
6 Internal Valve “Spool”
7 Valve “Body”
8 Lifting Jet Nozzles
9 Fire Attack Ports
10 Hose or “Pable” [Pipe Cable] Attachment
11 Pumping Force Source
12 Power Reservoir (Tank)
13 Fire Suppression Fluid Storage (Tank)
14 Hose/“Pable” Coil
15 Hose Storage Device
16 Cover
17 Photovoltaic Cells
18 Communications Antennae
19 Mounting Platform
20 Vehicle
21 Auxiliary Fire Assets

However, before proceeding with the description, it should be noted that the various embodiments shown and described herein are exemplary only and are not intended to represent the extent to which the present invention may be utilized. Indeed, the systems and methods described herein could be readily applied to any of a wide range of autonomous fire suppression nozzle and head assembly designs, as would be obvious to persons having ordinary skill in the art after having become familiar with the teachings provided herein. Consequently, the present invention should not be regarded as limited to the particular autonomous fire suppression nozzle and head assembly and example configurations shown and described herein.

### DETAILED DESCRIPTION

### Overview of Invention

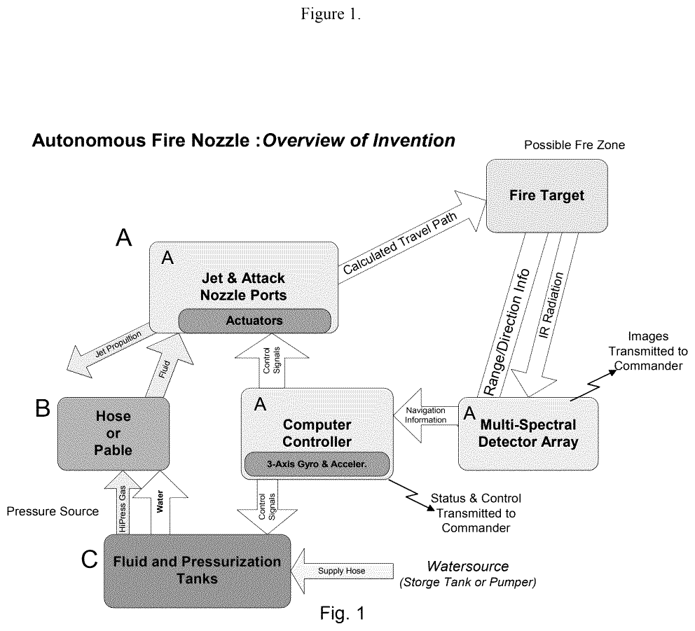

Referring now to FIG. 1, the autonomous fire suppression nozzle and head assembly A, communicates with Hose B, supplied by Fluid C. This invention relates to the nozzle and head assembly A.

### Nozzle and Head Description

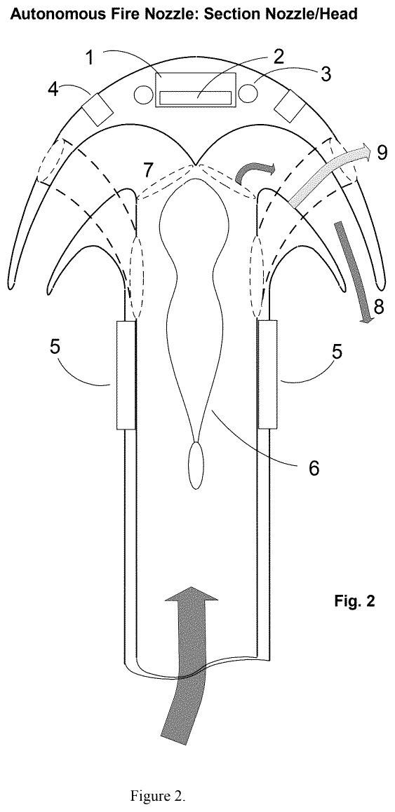

Referring now to FIG. 2, a sectional view of one embodiment of the autonomous fire suppression nozzle and head assembly A may comprise an upper chamber to hold the Guidance Computer/Communications Unit 1, in communication with a 3-Axis Gyroscope and 3-Axis Accelerometer 2, powered by an Electrical Power Source 3, connected to a Sensor Array 4, which by programmed logic to avoid obstacles and navigate to the fire, control fluid to a plurality of Valve Actuators 5, (communication not depicted) which cause the Internal Valve “Spool” 6, to cause the flow of fluid internal to the Valve “Body Cavity” 7, and allowing the plurality of Lifting Jet Nozzles 8, to move by flying the whole fire suppression nozzle and head assembly with attached hose, to allow delivery of suppression fluid through a plurality of Fire Attack Ports 9, towards the fire.

### System Operation

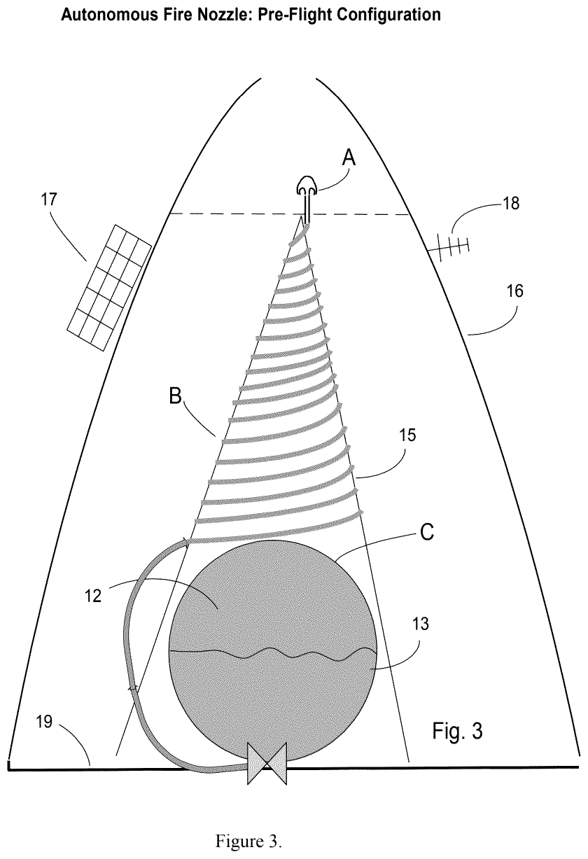

Referring now to FIG. 3, an overview of an embodiment of a fire fighting system showing the pre-flight mode, with the nozzle and head assembly attached and affixed atop the coil of hose. In the ready state, the system may be primed with sufficient pressure in the propellant tanks 12, in C. When the system receives a signal that a fire needs to be attacked, a valve (not detailed) is opened and when sufficient pressure and flow is achieved, the Nozzle and Head assembly A, is launched into the air and begins to move; it is in the “Travel” state. The fluid which, in one embodiment, may comprise a compressed gas, propels the Nozzle and Head assembly in generally arc-shaped path as the Hose B, is deployed from the Hose Storage Device 15. In an indoor design of the system, a compressed gas may be elected to provide pressure to “fly” to the suspected fire area so as not to “wet” the area under the flight path. Upon arrival, the aforementioned sensor array 4, provides the control system with information to determine if a fire threat exists and to switch to “Attack” mode by signaling Valve Actuators 5, directing the flow of fire suppression fluids, also directing valves at the fluid tank feeding the hose.

“Newton's Third Law of Motion, ‘For every action there is an equal and opposite reaction.’ As water leaves a nozzle under pressure, it causes a reactionary force in the opposite direction. The formula used for calculation of nozzle reaction is NR=1.57D²P.” [fireengineering.com] Where NR is nozzle reaction, D is the diameter of the hose, and P is the pressure. One embodiment of a system for a 1.5 inch diameter hose nozzle equivalent opening with a pressure of 150 pounds per square inch (PSI) would exceed well over 200 pounds of force. This force is sufficient to move/lift the nozzle/head unit and the hose filled with water a very long way, very quickly.

One possible embodiment of the autonomous fire suppression nozzle and head assembly is envisioned to be used for manually controlled configurations. A system can be provided with a suitable interface, as well as the various ancillary systems that may be desired or required for the operation of a remote controlled fire suppression nozzle and head assembly system, not described in further detail herein. Another embodiment would be the attachment of the autonomous fire suppression nozzle and head assembly to existing fire company hose and water source (i.e., pumper) then “launch” and control the device from a safe distance, with visual feedback to the firefighter remaining at the launch location.

Fluids having different viscosity and densities are possible and should be regarded as being within the scope of the present invention, provided suitable modifications are made to the autonomous fire suppression nozzle and head assembly system to allow different fluids to be used for different phases of operations: launch, travel, and attack.

An additional embodiment claimed of the present invention (not shown in the attached drawings), is of a fire fighting system where the invention is utilized for an outdoor canyon fire suppression mission. One embodiment is envisioned in a totally remote location strategically placed to provide unattended fire protection vigilance for a home or building. The system may incorporate an photovoltaic array, providing power for a small air-compressor (not depicted) to maintain pressure in the fluid and energy reservoir awaiting a “launch” signal from the guidance computer/communications Unit, after sensor input to determine the optimal time to begin the “travel” or flight mode. This configuration may be used in conjunction with other auxiliary fire assets, such as sprinklers, other vehicles, or firefighter teams, to assure higher success in defending the property from fire.

An additional embodiment claimed of the present invention (not shown in the attached drawings), is of a fire fighting system where the invention is utilized for a vehicle (aircraft or ship) fire suppression mission. Such an embodiment would provide unattended fire protection during adverse conditions, such as military naval operations, either in combat, or at port. Multiple autonomous fire suppression nozzle and head assemblies are envisioned to be located in high value locations such as: galleys, engine rooms, ammunition magazines, or communications areas. In an aircraft deployment smaller gaseous fire suppression fluids may be utilized in engine nacelles, fuel, electronic bays, or weapons locations.

An additional embodiment claimed of the present invention (not shown in the attached drawings) is to utilize a smaller shorter range and smaller capacity system in the trunk of a first responder squad car or emergency vehicle to be positioned in proximity to an automobile accident and/or fire, for initial suppression while additional fire department equipment and personnel are in transit.

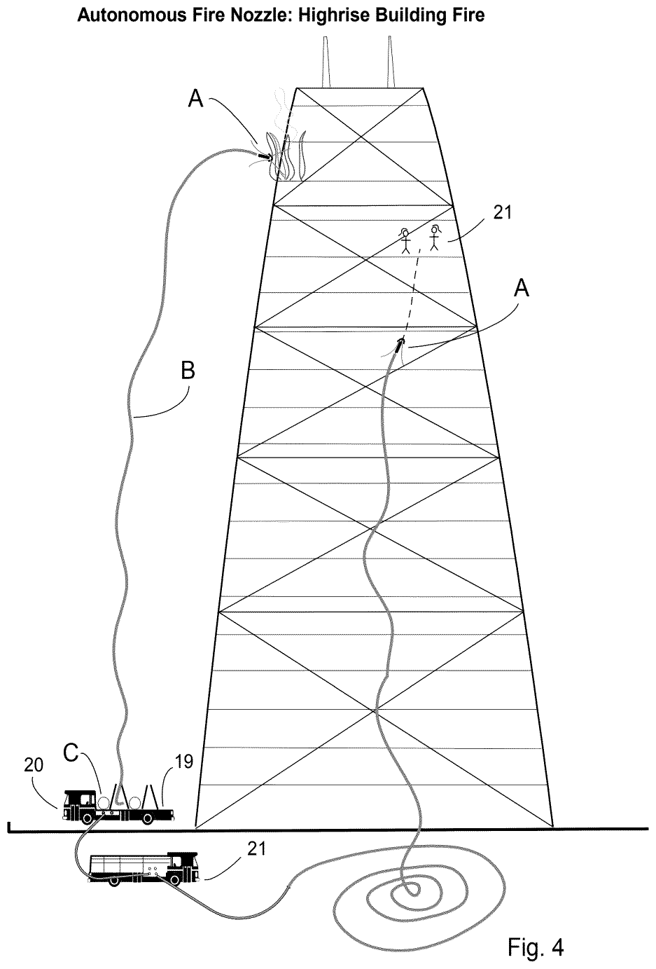

Referring now to FIG. 4, an additional embodiment of the present invention is to utilize the autonomous fire suppression nozzle and hose assembly as part of a fire battalion equipment asset by the application of a plurality of nozzle and head assembly units mounted on a firetruck or vehicle to deploy the system up many stories into a high-rise structure fire. The device may be utilized for quick delivery of larger diameter hoses to staged fire personnel in order to attack the fire with conventional techniques, or by utilization of the invention in combination with manual, remote controlled, or autonomous operations. The nozzle and head assembly unit may be used with conventional pumpers and carefully coiled hose ready for flying into tall structures, since upon launch the nozzle and head assembly is self-stabilized.

An additional embodiment of the present invention is to utilize the autonomous fire suppression nozzle and head assembly as part of system to suppress fires in an industrial facility or park, e.g. Petrochemical Plants, large industrial sites, tank farms, and storage yards. In this embodiment the autonomous fire suppression nozzle and head assembly deployed from a tactical location in conjunction with traditional fire monitors is desired and therefor the total fire suppression system would be more effective. Those persons having ordinary skill in the art could readily apply autonomous fire suppression nozzle and head assembly technology such as required with fixed water monitor systems.

One embodiment of the present invention would have an autonomous fire suppression nozzle and head assembly system mounted on vehicles: airships, boats, rail cars, or trucks, for transportable fire fighting applications.

In summation, then, because persons having ordinary skill in the art could readily select from one or several component configurations of the design described herein, after having become familiar with the teachings of the present invention, the present invention should not be regarded as limited to varying any one or combination of the autonomous fire suppression nozzle and head assembly components or systems described herein.

Present invention should not be regarded as limited to any kind of fire suppression fluid. Present invention should not be regarded as limited to any kind of pumping technology, conventional or stored energy (compressed gas or gravity tower) system.

Present invention should not be regarded as limited to any scale of fluid output. Present invention should not be regarded as limited to any particular fluid source or combination of fluid sources. Present invention should not be regarded as limited to any hose or pable (pipe cable) single or multiple conduits of communication, or combinations, of fluids or gasses.

Present invention should not be regarded as limited to any installation configuration: subterranean or surface structures, stationary or mobile application as in surface ships, airships, spacecraft, or as small transportable fire suppression units for military or civilian applications.

Present invention should not be regarded as limited to any fluid delivery use or purpose, either as a fire suppression system, or as the source of fire to create a fire break or in a militarized embodiment such as a flame thrower for anti-piracy or military defensive and/or offensive applications.

Having herein set forth some embodiments of the present invention, it is anticipated that suitable modifications can be made thereto which will nonetheless remain within the scope of the invention. The invention shall therefore only be construed in accordance with the specific included claims.

I claim the invention is:

1. An autonomous fire suppression device, in which the mass transferred by fluid flow is utilized to generate reactive motive force, comprising:
an autonomous fire suppression nozzle and head assembly which is a self-guided, self-propelled, fire-detecting, hose delivery device for the application of fire suppression fluids or gasses, the improvement being transported via reactive jet propulsion, while utilizing no external moving parts, by the principle of acceleration of a fluid through a jet nozzle, and utilizing the hydraulic force of fluid pressure to propel the device;
a single internal electromagnetic-fluidic hydraulic valve core enclosed within the body cavity of the nozzle and head assembly surrounded by a plurality of ports that control the travel and delivery functions of the device for fire suppression fluids and gasses;
an electronic control unit, the improvement comprising of: (a) guidance computer with a wireless communications unit, in communication with (b) a 3-axis gyroscope and (c) a 3-axis accelerometer, powered by (d) a self-contained electrical power source, and (e) communicating to a sensor array, which is programmed by logic to avoid obstacles, navigate to the fire, and control fluid by a (f) plurality of valve actuators which cause (g) an internal valve spool, to divert the flow of fluid internal to the (h) valve body thus allowing (i) lifting jet nozzles to move the assembly by reactive jet propulsion to allow delivery of suppression fluid through (j) fire attack ports.

2. A fire suppression system with an autonomous fire suppression device according to claim 1, comprising:
A collection of components, the improvement comprising: (a) the nozzle and head assembly which is a self-guided, self-propelled, and fire detecting, (b) a source of pressurized fluid, (c) a hose system to communicate said fluid, (d) a hose storage device, and (d) a housing for the components;
a means for communicating status of the system to other fire fighting assets;
a means for transportation and deployment.

3. A manual fire suppression system with an autonomous fire suppression device according to claim 1, comprising a collection of components, the improvement comprising: (a) the nozzle and head assembly which is self-stabilized and self-propelled, (b) a source of pressurized fire suppression fluid, (c) a hose system to communicate said fluid, (d) a hose storage device, and (e) a means for directing the path of travel of said device by a firefighter.

4. A vehicle mounted automatic fire suppression system with an autonomous fire suppression device according to claim 1, comprising a collection of components, the improvement comprising: (a) the nozzle and head assembly which is self-stabilized, self-guided, self-propelled, and fire detecting, (b) the source of pressurized fire suppression fluid, (c) the hose system to communicate said fluid, (d) a hose storage device within a vehicle, and (f) a means for initiating the launch of the device into a fire.
